(19) United States
(12) Patent Application Publication
(10) Pub. No.: US 2003/0168792 A1
(43) Pub. Date: Sep. 11, 2003

(54) Coil spring

(76) Inventor: John Philip Roger Hammerbeck, London (GB)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/311,904

(22) PCT Filed: Jun. 19, 2001
(86) PCT No.: PCT/GB01/02701

(30) Foreign Application Priority Data
Jun. 19, 2000 (GB) 0014974.0
Jul. 21, 2000 (GB) 0017998.6

(51) Int. Cl. F16F 1/06; B60G 11/14

(52) U.S. Cl. 267/180; 267/166

(57) ABSTRACT

A coil spring 10 having a plurality of windings 12, at least two of the windings 12 being hinged together.

The present invention relates to a coil spring and a method for joining the windings of a coil spring.

Coil springs have many practical uses. They can, for example, be used as a drive belt as described in WO 00/19125. In this situation, the spring is typically stretched and bent round a pulley system. When the spring is driven round the pulley its inner edges are strained. This strain limits the potential expansion available. This is a disadvantage. A further disadvantage is that the staining of the spring as it moves round the pulley can cause damage. In addition, the strain or torsion means that there are practical lower limits to the diameter of the pulley that can be employed.

An object of the present invention is to provide an improved coil spring.

Various aspects of the present invention are defined in the accompanying independent claims. Some preferred features are defined in the dependent claims.

According to one aspect of the present invention there is provided a coil spring having a plurality of windings, at least two of the windings being hinged together.

The ends of the windings may define the hinge. For example. the hinge may be formed using twisted end portions of adjacent windings, which end portions are operable to be inter-linked. Alternatively, each winding may have a male screw formed at one end and a female socket formed at the other end, so that adjacent windings can be hinged together by turning the male screw into the female socket.

The hinge may comprise a hinge member that is adapted to connect adjacent windings together. Preferably, the hinge member is a double-ended spiked screw, each end being adapted to be screwed into a cavity at the end of adjacent windings. Preferably, the double-ended screw has one thread turn formed thereon.

Preferably, all windings of the spring are hinged to adjacent windings.

The or each winding may be made of carbon fibre. The windings may all be made of the same material. Alternatively, the windings may be made of different material. For example, windings close to either end of the spring may be made of a stronger material than those positioned towards a middle portion of the spring. The windings may be made of progressively stronger material closer to the ends of the spring, the winding at the end of the spring being made of the strongest material.

The windings may be shaped so as to provide a spring with a variable winding spacing or pitch.

According to another aspect of the present invention there is provided a coil spring having a plurality of windings and an end piece that is hinged to an end winding of the spring. Preferably, there is an end piece at each end of the spring, each end winding being hinged to the adjacent end piece. The end piece may be made of a different material to that of the windings. Preferably, the end piece is made of a stronger material than that of the windings.

The spring in which the second aspect of the invention is embodied may have all the features of the spring in which the first aspect of the invention is embodied.

According to yet another aspect of the present invention, there is provided a coil spring comprising a plurality of windings that have a pitch that varies along the length of the spring, when the spring is in an untensioned state.

According to still another aspect of the present invention there is provided a method of making a coil spring comprising forming a hinge between at least two of the windings.

The step of forming a hinge may comprise twisting or forming end portions of adjacent-windings so that the end portions can be interlinked.

The step of forming a hinge may comprise forming a male screw at one end of the winding and a female socket at the other end, so that adjacent windings can be hinged together by turning the male screw into the female socket.

The step of forming a hinge may comprise connecting adjacent windings using a hinge member. Preferably the hinge member comprises a double-ended screw, which is adapted to be received in a cavity that is formed in the end of adjacent windings.

The windings may be made of the same material. The windings may be made of different material. For example, windings close to either end of the spring may be made of a stronger material than those positioned towards a middle portion of the spring. The windings may be made of progressively stronger material closer to the ends of the spring.

The windings may be shaped so as to provide a spring with a variable winding spacing or pitch.

Various springs in which the present invention is embodied will new be described by way of example only and with reference to the following drawings, of which:

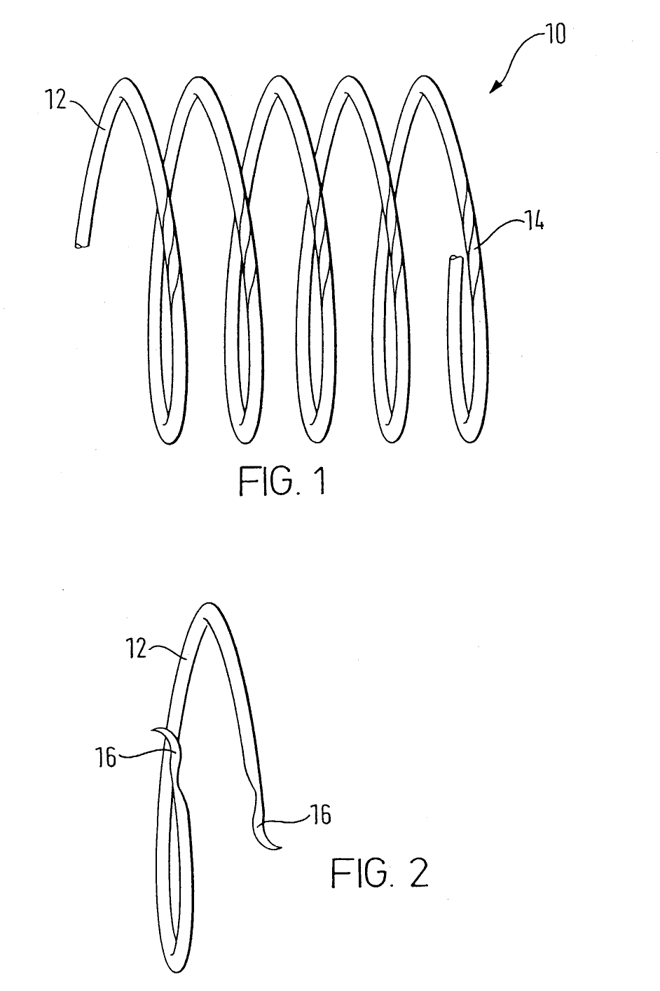

FIG. 1 is a schematic view of a first spring;

FIG. 2 is a single loop winding of the spring of FIG. 1;

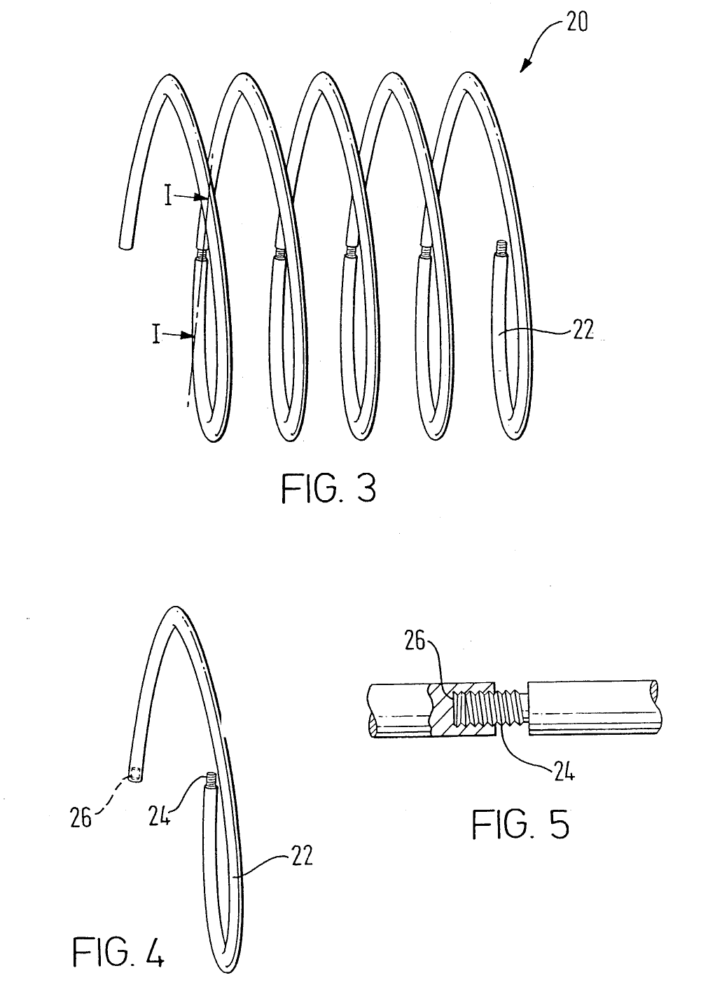

FIG. 3 is a schematic view of another spring;

FIG. 4 is a single loop winding of the spring of FIG. 3;

FIG. 5 is a section through the line I-I of FIG. 3;

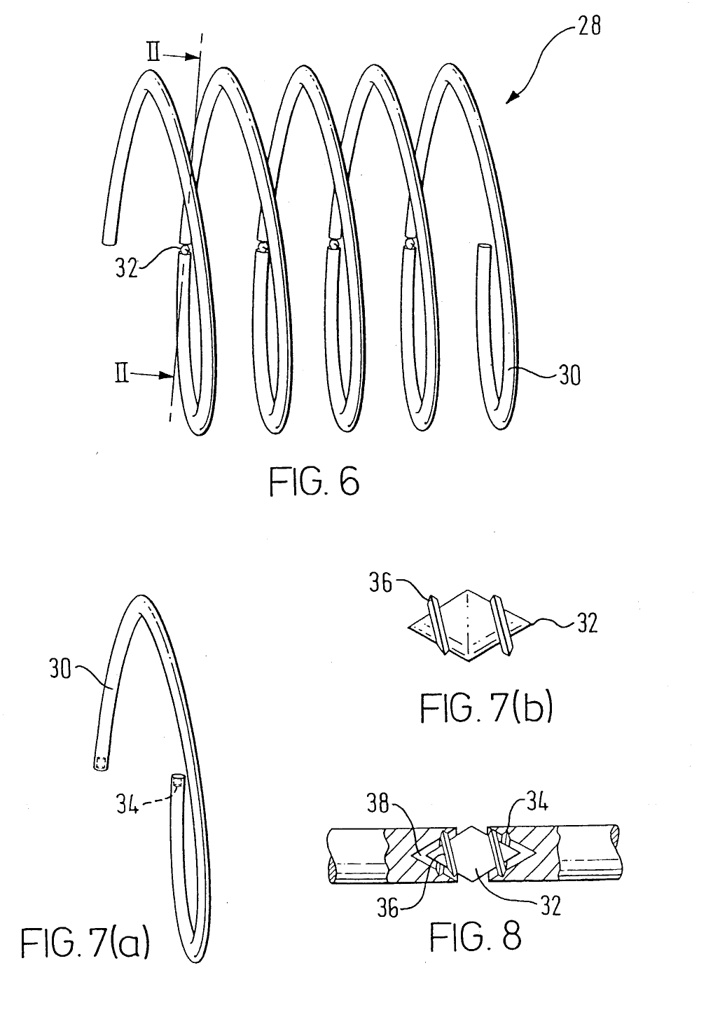

FIG. 6 is a schematic view of another spring;

FIGS. 7(a) and (b) show parts of the spring of FIG. 6,

FIG. 8 is a section through line II-II of the spring shown in FIG. 6;

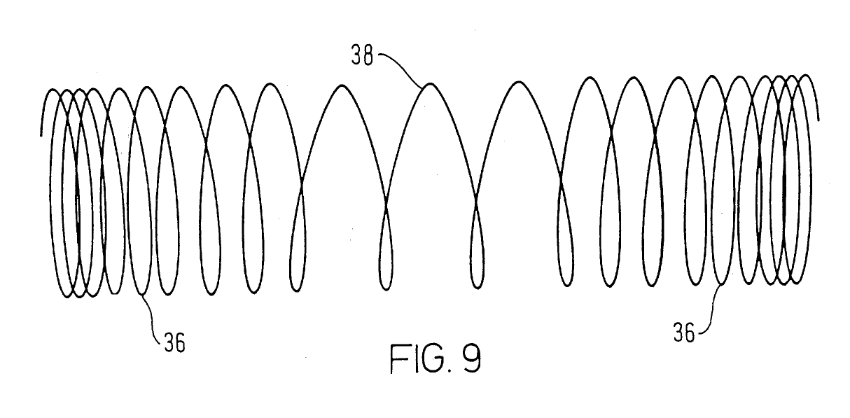

FIG. 9 is a schematic view of a spring that has a variable pitch along its length;

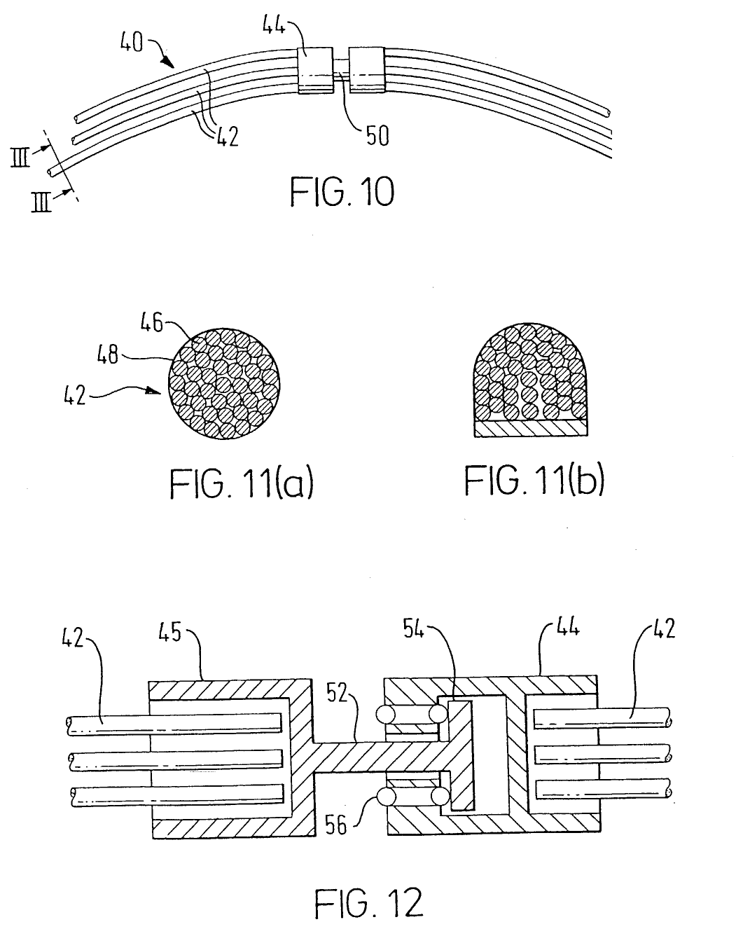

FIG. 10 is side view of a hinged portion of a large spring;

FIG. 11(a) is a transverse section on the line III-III through a first example of a bundle of coils of the spring of FIG. 10;

FIG. 11(b) is a transverse section on the line III-III through a second example of a bundle of coils of the spring of FIG. 10; FIG. 12 is a cross section through a hinge of the spring of FIG. 10;

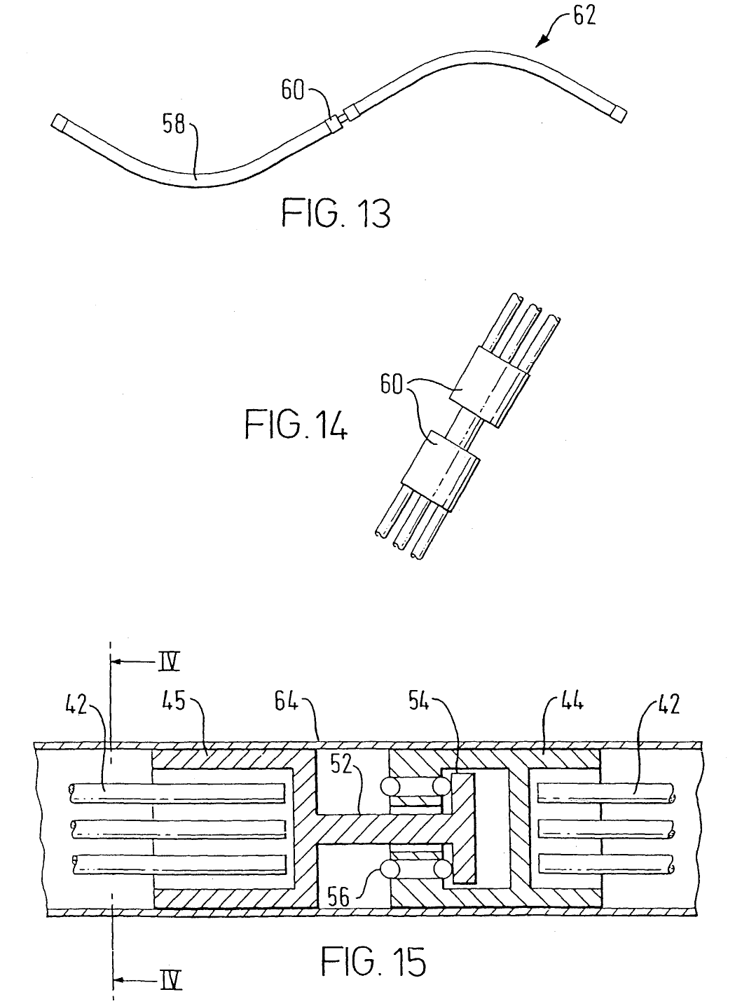

FIG. 13 is a schematic representation of a hinged spring that has an elongated pitch;

FIG. 14 is a detailed view of a hinge of the spring of FIG. 13;

FIG. 15 is a cross section through a spring that is enclosed in an outer sheath;

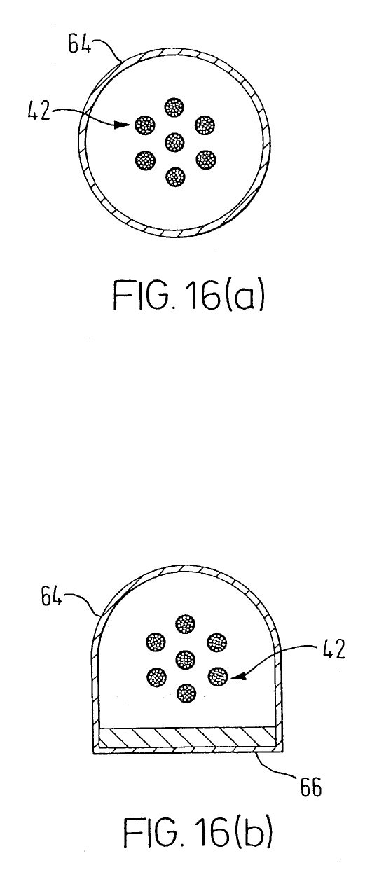

FIG. 16(a) is a transverse section on the line IV-IV through a first example of the spring of FIG. 15, and

FIG. 16(b) is a transverse section on the line IV-IV through a second example of the spring of FIG. 15.

FIG. 1 shows a spring 10 having a plurality of single loop windings 12 that are joined together using hinges 14, which hinges 14 are formed by interlacing the ends 16 of the loops 12.

In order to make the spring 10, the ends 16 of each winding are twisted or deformed, as shown in FIG. 2, so that they can be interlinked with a like winding in a hand-shake type hinge 14. By repeating this linking process, a plurality of windings 12 can be connected to form the spring 10.

At the ends of the spring 10, end pieces (not shown) that are made of a relatively strong material, typically stronger than that of the windings, are connected. These end pieces are also hinged to the adjacent windings.

If the spring 10 is to be used as a drive belt, it is preferable to shape the twisted end portions 16 so that when inter-linked, the resultant hinge 14 is flush with the adjacent windings 12. In this way, the line or profile of the windings 12 is substantially unaffected by the presence of the hinge 14.

The windings 12 of the spring of FIG. 1 are able to rotate about an axis of the hinge 14, which axis is substantially tangential to the spring (or substantially parallel to a tangent of the spring). The hinge 14 is such that the windings 12 do not separate during in normal use thereof.

FIG. 3 shows a spring 20 having a plurality of like, single loop windings 22 that are hinged together by turning a male screw that is formed in the end of one winding into a female socket that is formed in the end of an adjacent winding.

In order to make the spring of FIG. 3, one end of each winding 22 is formed with a male screw 24 and the other end is formed with a threaded female socket 26 as shown in FIG. 4. The male screws 24 are adapted to be received in the female sockets 26 of adjacent windings as shown in FIG. 5. In this way, the spring 20 can be formed by turning the male screw 24 of one winding into the female socket 26 of the adjacent winding, so that they are hinged together. By repeating this process, a plurality of windings 22 can be connected to form the spring 20.

As before, at the ends of the spring 20, end pieces (not shown) that are made of a relatively strong material, typically stronger than that of the windings, are hinged or pivotably connected to the end windings.

The windings of the spring of FIG. 3 are able to rotate about an axis of the hinge, which axis is substantially tangential to the spring (or substantially parallel to a tangent of the spring). The hinge is, however, such that the windings 22 do not separate during in normal use thereof.

FIG. 6 shows a spring 28 having a plurality of single loop windings 30 that are joined together using a double-ended spiked screw 32, see FIGS. 7(a) and (b) respectively. Each end of the screw 32 is adapted to be screwed into a threaded recess 34 that is formed in the ends of the windings 30. Typically, the double-ended screw has one thread turn 36 formed on it, which extends, at least partially, over both ends of the screw 32.

In order to assemble the spring of FIG. 6, the double ended screw 32 is screwed into the recess 34 in the end of one of the loops 30. Screwed onto the other end of the screw 32 is another winding 30. Typically, a gap 38 is left between the windings 30, as shown in FIG. 8. This gap 38 allows a small amount of rotation of each winding 30 towards and relative to the adjacent windings.

By repeating the above mentioned assembly steps, a plurality of the windings 30 can be connected to form a spring 30. As before, at the ends of the spring 10, end pieces (not shown) that are made of a relatively strong material, typically stronger than that of the windings, are hinged or pivotably connected to the end windings.

As will be appreciated, once the spring 28 of FIG. 6 is assembled, the windings 30 can rotate slightly relative to each other about an axis of each hinge, which axis is substantially tangential to the winding itself. The hinges are, however, such that the windings 30 do not separate when the spring is in use.

The springs described herein can be made of any suitable material, for example stainless steel or carbon fibre.

In most circumstances, when the springs 10 and 20 shown in FIGS. 1, 3 and 6 are used, they behave in a normal fashion, but when bent round a pulley, the spacing between the windings on the inner edge remains unchanged. Furthermore, the torsion on the inner edge of the spring is relieved by a slight rotation of the windings about the hinges. This is advantageous.

Whilst the springs that are shown in FIGS. 1, 3 and 6 are formed from a series of windings that are of essentially of the same length, thereby to define a uniform winding pitch along the spring, the windings could have different individual lengths. Hence, the spring could have a non-uniform winding pitch along its length. FIG. 9, for example, shows a spring in which the windings near the ends of the spring 36 are relatively close together, whilst those in the middle 38 are somewhat further apart. The spring shown in FIG. 9 is, of course, shown in a non-tensioned state.

The method of making springs in which the invention is embodied is useful for assembling large springs, which can be made piece by piece. In this case, each winding of the spring could itself be comprised of bundles of separate coils that are joined at their ends. FIG. 10 shows an example of this, in which each winding 40 comprises a plurality of bundles of coils 42 that are secured together in a cup-shaped end piece 44. As can be seen in Figures 11(a) and (b), each bundle 42 has a plurality of coils 46 that are held together in an outer sheath 48. In cases where the spring is to be used in contact with another part, for example, as the drive belt of the variable speed drive disclosed in WO 00/19125, it can be useful to form the sheath 48 in such a manner that the spring has a relatively flat outer surface 49. This is shown in FIG. 11(b). In this way, contact with the spring can be improved.

Formed at the end of each cup 44 is part of a hinge that is interlockable with another part on an adjacent cup 44, thereby to form a hinge 50 about which the windings can move. Any suitable hinge can be used. FIG. 12 shows an example of a pin hinge. In this, a pin 52 with a headed portion 54 extends from an end of one cup 44 and is received in the adjacent cup 44. In order to reduce friction between the pin head 54 and the interior of the adjacent cup 44, a roller bearing 55 is provided, against which the pin head 54 can rotate. A further bearing 56 provides a bearing surface between the adjacent cup parts 44. As before, the windings of the springs of FIGS. 10 and 12 are able to rotate about an axis of the hinge 50, which axis is substantially tangential to the spring (or substantially parallel to a tangent of the spring). The hinge 50 is, however, such that the windings 22 do not separate during in normal use thereof.

To detect failure of individual coils of the spring of FIG. 10, sensors (not shown) can be placed adjacent to the hinge in order to measure the separation of the end cups 44 when the spring is under tension. In the event that the separation of the end cups 44 increases beyond a pre-determined amount, this can be used as an indication that at least one of the coils of the bundles 42 has broken. This provides an early warning of possible failure. This is useful in applications where the spring is under considerable tension.

In cases where the spring is to be used as a drive belt, for example as described in WO 0019125, and is constantly rotating around an endless path, the sensors may be adapted to (a) measure the separation of the end caps of each hinge as it passes a pre-determined point and (b) store that value. Hence, for every hinge there is a stored value of the separation of the end caps. When a given hinge next passes the sensor, the separation is measured again and compared with the stored value. In the event that the values are substantially the same, this provides re-assurance that the adjacent windings are un-damaged. In the event that the values are different, this provides an indication that the adjacent windings may be damaged. In this way, the condition of each winding of the spring can be monitored.

The spring of FIG. 10 and its method of manufacture are simple and cost effective compared to current day springs and methods or manufacture. In addition, because each winding of the spring comprises a plurality of coils, breakage of one coil is not critical. This is advantageous.

In some applications, in particular for some large springs, it may be desirable for the windings to have a relatively elongate pitch. In this case, the hinge should be aligned with the direction of the coil. An example of this is shown in FIGS. 13 and 14. In this case, the spring is similar to that of FIG. 10 in the sense that it has bundles of coils 58 secured together in cup-shaped end pieces 60. However, each winding 62 has a long pitch and the end cups 60 are shaped so as to be substantially aligned with the direction of the spring, in its untensioned state. This is shown in detail in FIG. 14.

The springs described above all have a plurality of windings that are hinged together. In order to avoid dirt deteriorating the hinges or where the spring is to move for example around a drive wheel, the spring or indeed merely the hinges could be encased in an outer sleeve or sheath. FIG. 15 shows an example of the spring of FIG. 12 encased in a sleeve 64. The outer sleeve 64 can be, for example, circular as shown in FIG. 16(a) or may be shaped so as to provide a flat outer surface 66 for the spring, as shown in FIG. 16(b).

The springs in which the present invention is embodied have many advantages. For example, in the event of breakage a winding somewhere along the length of the spring, because individual windings are hinged together and can be separated, this means that it is only necessary to replace the broken winding, instead of the entire spring.

The method of assembly in which the invention is embodied also makes tempering of a spring easier. In addition, by linking a plurality of windings together, it is possible to simplify the manufacture of endless springs. Furthermore, the method could be used to join a winding to the end piece of a spring. Hence, the end of the spring could be made of a different, stronger material. This is advantageous because the ends of traditional springs are often weak and so prone to breaking.

Equally, by linking together a plurality of separate windings to form the spring, the windings may be made of different material. For example, windings close to either end of the spring may be made of a stronger material than those positioned towards a middle portion of the spring. The windings may be made of progressively stronger material closer to the ends of the spring. This is also advantageous because springs tend to be subjected to most force towards their ends. By making the windings stronger towards the ends of the spring, this reduces the likelihood of the spring being damaged.

A skilled person will appreciate that variations of the disclosed arrangements are possible without departing from the invention. Accordingly, the above description of the specific embodiments is made by way of example and not for the purposes of limitation. It will be clear to the skilled person that minor modifications can be made without significant changes to the springs described above.

1. A coil spring having a plurality of windings, at least two of the windings being hinged together.

2. A coil spring as claimed in claim 1, wherein end portions of the windings co-operate to define a hinge.

3. A coil spring as claimed in claim 2, wherein the hinge is formed by twisting or deforming the end portions of the windings so that they are inter-linkable.

4. A coil spring as claimed in claim 2, wherein one of the end portions defines a male part of the hinge and the other defines a female part of the hinge, the male part being adapted to be received in the female part.

5. A coil spring as claimed in claim 4, wherein the male part of the hinge is a screw and the female part is a threaded socket.

6. A coil spring as claimed in claim 1, comprising a hinge that has a hinge member that is adapted to connect the windings.

7. A coil spring as claimed in claim 6, wherein the hinge member is a double-ended screw, each end being adapted to be screwed into a cavity at the end of adjacent windings.

8. A coil spring as claimed in claim 7, wherein the double-ended screw has one thread turn formed thereon.

9. A coil spring as claimed in any one of the preceding claims, wherein all windings of the spring are hinged to adjacent windings.

10. A coil spring as claimed in any one of the preceding claims, wherein the spring has an end piece, which end piece is hinged to an adjacent winding.

11. A coil spring as claimed in any one of the preceding claims, wherein the windings are each made of the same material.

12. A coil spring as claimed in any one of claims 1 to 10, wherein at least one of the windings is made of a different material from the or each of the other windings.

13. A coil spring as claimed in claim 12, wherein windings towards an end of the spring are made of a relatively stronger material than the windings that are located towards a middle portion of the spring.

14. A coil spring as claimed in claim 13, wherein the windings towards the end of the spring are made of progressively stronger material.

15. A coil spring having a plurality of windings and an end piece that is hinged to an adjacent winding.

16. A coil spring as claimed in claim 15, wherein an end piece is provided at each end of the spring.

17. A coil spring as claimed in claim 15 or claim 16, wherein the end piece is made of a different material to that of the windings.

18. A coil spring as claimed in claim 17, wherein the end piece is made of a stronger material than that of the windings.

19. A coil spring as claimed in any one of the preceding claims, wherein the spring has a winding pitch or spacing that varies along its length.

20. A coil spring as claimed in any one of the preceding claims, wherein at least one winding of the spring comprises a plurality of individual coils that are joined so as to form a single winding.

21. A coil spring as claimed in claim 20, wherein the plurality of coils are bound together in a sheath.

22. A coil spring as claimed in any one of the preceding claims, wherein each winding has a relatively long pitch.

23. A method of forming a coil spring having a plurality of windings, the method comprising forming a hinge between at least two of windings.

24. A method as claimed in claim 23, wherein the step of forming the hinge comprises twisting or forming end portions of adjacent windings so that the end portions can be interlinked.

25. A method as claimed in claim 23, wherein the step of forming a hinge comprises connecting adjacent windings using a hinge member.

26. A method as claimed in claim 23, wherein the hinge member comprises a double-ended screw, which is adapted to be received in a cavity that is formed in the end of adjacent windings.

27. A method as claimed in claim 26, wherein the double-ended screw has one thread turn formed on it.

28. A coil spring substantially as described hereinbefore and as shown in the accompanying drawings.

29. A method of forming a coil spring substantially as described hereinbefore with reference to the accompanying drawings.
